(19) United States
(12) Patent Application Publication
(10) Pub. No.: US 2015/0078497 A1
(43) Pub. Date: Mar. 19, 2015

(54) RECEIVER CARRIER AGGREGATION FREQUENCY GENERATION

(71) Applicant: QUALCOMM Incorporated, San Diego, CA (US)

(72) Inventors: Gang ZHANG, San Diego, CA (US); Frederic BOSSU, San Diego, CA (US)

(73) Assignee: QUALCOMM Incorporated, San Diego, CA (US)

(21) Appl. No.: 14/265,877

(22) Filed: Apr. 30, 2014

Related U.S. Application Data
(60) Provisional application No. 61/877,454, filed on Sep. 13, 2013.

(51) Int. Cl. H04L 27/26

(52) U.S. Cl. CPC H04L 27/2647
USPC 375/347

(57) ABSTRACT

Certain aspects of the present disclosure provide methods and apparatus for generating local oscillator (LO) signals for multiple receive chains. One example circuit for generating first and second signals generally includes a first voltage controlled oscillator (VCO) configured to output the first signal at a first frequency and associated with a first receive chain for receiving a first carrier of an aggregated resource; and a second VCO configured to output the second signal at a second frequency and associated with a second receive chain for receiving a second carrier of the aggregated resource. The second frequency is different than the first frequency. In this manner, pulling or coupling between the two VCOs may be avoided, even if the two VCOs are implemented on the same radio frequency integrated circuit (RFIC).

### CLAIM OF PRIORITY UNDER 35 U.S.C. §119

This application claims benefit of U.S. Provisional Patent Application Ser. No. 61/877,454, filed Sep. 13, 2013 and entitled “Receiver Carrier Aggregation Frequency Generation,” which is herein incorporated by reference in its entirety.

### TECHNICAL FIELD

Certain aspects of the present disclosure generally relate to wireless communications and, more particularly, to generating local oscillator (LO) signals for multiple receive chains.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. For example, one network may be a 3G (the third generation of mobile phone standards and technology) system, which may provide network service via any one of various 3G radio access technologies (RATs) including EVDO (Evolution-Data Optimized), 1×RTT (1 times Radio Transmission Technology, or simply lx), W-CDMA (Wideband Code Division Multiple Access), UMTS-TDD (Universal Mobile Telecommunications System—Time Division Duplexing), HSPA (High Speed Packet Access), GPRS (General Packet Radio Service), or EDGE (Enhanced Data rates for Global Evolution). The 3G network is a wide area cellular telephone network that evolved to incorporate high-speed internet access and video telephony, in addition to voice calls. Furthermore, a 3G network may be more established and provide larger coverage areas than other network systems. Such multiple access networks may also include code division multiple access (CDMA) systems, time division multiple access (TDMA) systems, frequency division multiple access (FDMA) systems, orthogonal frequency division 3rd multiple access (OFDMA) systems, single-carrier FDMA (SC-FDMA) networks, Generation Partnership Project (3GPP) Long Term Evolution (LTE) networks, and Long Term Evolution Advanced (LTE-A) networks.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station.

### SUMMARY

Certain aspects of the present disclosure generally relate to generating local oscillator (LO) signals for multiple receive chains. One example of this is in dual (or more) receive chains for carrier aggregation supported in certain radio access technologies, such as LTE-A.

Certain aspects of the present disclosure provide a circuit for generating a first signal and a second signal. The circuit generally includes a first voltage controlled oscillator (VCO) configured to output the first signal at a first frequency and associated with a first receive chain for receiving a first carrier of an aggregated resource; and a second VCO configured to output the second signal at a second frequency and associated with a second receive chain for receiving a second carrier of the aggregated resource. The second frequency is different than the first frequency.

Certain aspects of the present disclosure provide a local oscillator (LO) generation circuit for generating first and second local oscillating signals. The LO generation circuit generally includes a first VCO configured to output a first signal at a first frequency and associated with a first receive chain for receiving a first carrier of an aggregated resource; a first frequency dividing circuit configured to divide the first frequency of the first signal to generate the first local oscillating signal; a second VCO configured to output a second signal at a second frequency and associated with a second receive chain for receiving a second carrier of the aggregated resource, wherein the second frequency is different than the first frequency; and a second frequency dividing circuit configured to divide the second frequency of the second signal to generate the second local oscillating signal.

Certain aspects of the present disclosure provide an apparatus for wireless communications. The apparatus generally includes a first antenna, a second antenna, a first receive chain configured to mix a first carrier of an aggregated resource received via the first antenna with a first local oscillating signal, a second receive chain configured to mix a second carrier of the aggregated resource received via the second antenna with a second local oscillating signal, and a LO generation circuit for generating the first and second local oscillating signals. The LO generation circuit generally includes a first VCO configured to output a first signal at a first frequency, wherein the first VCO is associated with the first receive chain; a first frequency dividing circuit configured to divide the first frequency of the first signal to generate the first local oscillating signal; a second VCO configured to output a second signal at a second frequency, wherein the second VCO is associated with the second receive chain and wherein the second frequency is different than the first frequency; and a second frequency dividing circuit configured to divide the second frequency of the second signal to generate the second local oscillating signal.

According to certain aspects, the first VCO and the second VCO are implemented on a single integrated circuit (IC). For other aspects, the first and second VCO may be implemented on separate ICs.

According to certain aspects, the first frequency is one half of the second frequency. For example, the first frequency may be 4 GHz, and the second frequency may be 8 GHz. For other aspects, the first frequency is one third or two thirds of the second frequency. For example, the first frequency may be 4 GHz, and the second frequency may be 6 GHz or 12 GHz.

According to certain aspects, the first frequency dividing circuit includes at least one of a divide-by-2 circuit or a divide-by-4 circuit. For certain aspects, the second frequency dividing circuit includes a first stage configured to initially divide the second frequency of the second signal and a second stage for subsequently frequency dividing an output signal of the first stage to generate the second local oscillating signal. The first stage may include at least one of a divide-by-1.5 circuit, a divide-by-2 circuit, or a divide-by-3 circuit. The second stage may include at least one of a divide-by-2 circuit or a divide-by-4 circuit.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communications network in accordance with certain aspects of the present disclosure.

FIG. 2 is a block diagram of an example access point (AP) and user terminals in accordance with certain aspects of the present disclosure.

FIG. 3 is a block diagram of an example frequency generating circuit for receiver carrier aggregation, in accordance with certain aspects of the present disclosure.

FIG. 4A illustrates an example primary carrier aggregation frequency plan for the circuit of FIG. 3, in accordance with certain aspects of the present disclosure.

FIG. 4B illustrates an example secondary carrier aggregation frequency plan for the circuit of FIG. 3, in accordance with certain aspects of the present disclosure.

### DETAILED DESCRIPTION

Various aspects of the present disclosure are described below. It should be apparent that the teachings herein may be embodied in a wide variety of forms and that any specific structure, function, or both being disclosed herein is merely representative. Based on the teachings herein, one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects.

The techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), Single Carrier Frequency Division Multiple Access (SC-FDMA), Time Division Synchronous Code Division Multiple Access (TD-SCDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement Institute of Electrical and Electronics Engineers (IEEE) 802.11, IEEE 802.16, Long Term Evolution (LTE) (e.g., in TDD and/or FDD modes), or some other standards. A TDMA system may implement Global System for Mobile Communications (GSM) or some other standards. These various standards are known in the art.

### An Example Wireless System

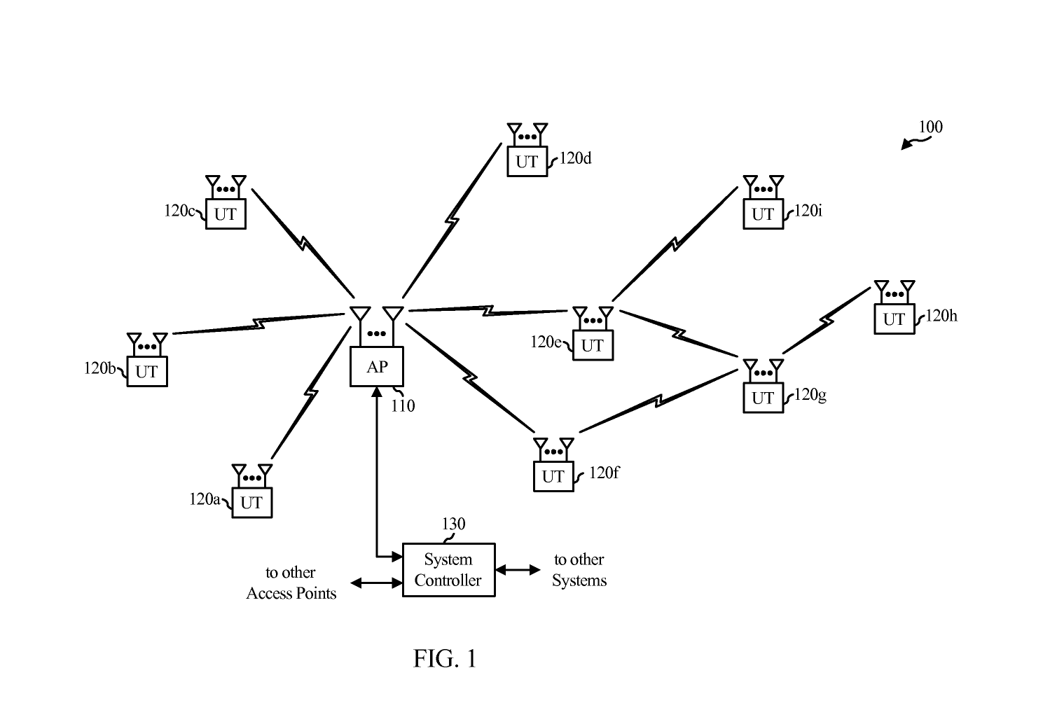

FIG. 1 illustrates a wireless communications system 100 with access points and user terminals. For simplicity, only one access point 110 is shown in FIG. 1. An access point (AP) is generally a fixed station that communicates with the user terminals and may also be referred to as a base station (BS), an evolved Node B (eNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

Wireless system 100 may be a time division duplex (TDD) system or a frequency division duplex (FDD) system. For a TDD system, the downlink and uplink share the same frequency band. For an FDD system, the downlink and uplink use different frequency bands. System 100 may also utilize a single carrier or multiple carriers for transmission. Each user terminal may be equipped with a single antenna (e.g., in order to keep costs down) or multiple antennas (e.g., where the additional cost can be supported).

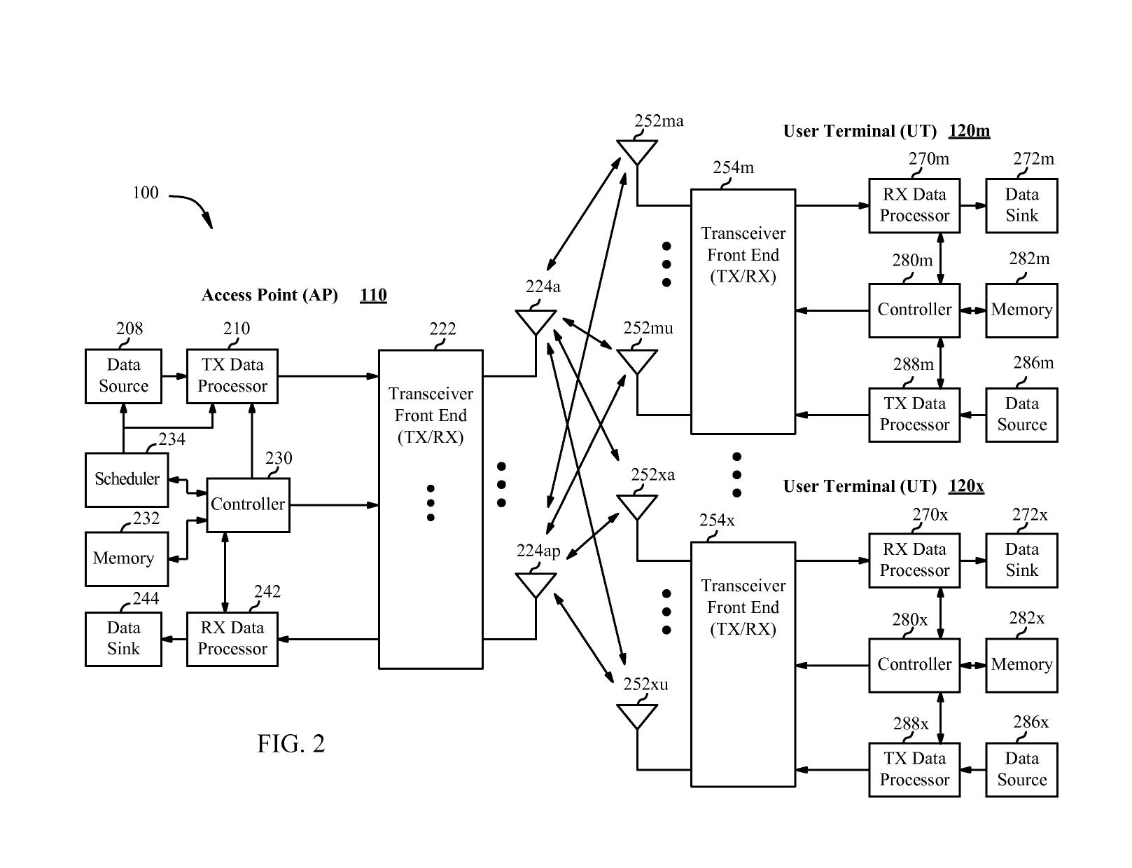

FIG. 2 shows a block diagram of access point 110 and two user terminals 120m and 120x in wireless system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nₐₚ user terminals are selected for simultaneous transmission on the uplink, N_{dn} user terminals are selected for simultaneous transmission on the downlink, Nₐₚ may or may not be equal to N_{dn}, and Nₐₚ and N_{dn} may be static values or can change for each scheduling interval. Beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ} for one of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one of the N_{ut,m} antennas for transmit diversity via an RF switch, for example. The controller 280 may control the routing within the transceiver front end 254.

A number Nₐₚ of user terminals may be scheduled for simultaneous transmission on the uplink. Each of these user terminals transmits its set of processed symbol streams on the uplink to the access point.

At access point 110, Nₐₚ antennas 224a through 224ap receive the uplink signals from all Nₐₚ user terminals transmitting on the uplink. For receive diversity, a transceiver front end 222 may select signals received from one of the antennas 224 for processing. For certain aspects of the present disclosure, a combination of the signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal. An RX data processor 242 processes (e.g., demodulates, deinterleaves, and decodes) the recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 may provide a downlink data symbol streams for one of more of the N_{dn} user terminals to be transmitted from one of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222.

At each user terminal 120, N_{ut,m} antennas 252 receive the downlink signals from access point 110. For receive diversity at the user terminal 120, the transceiver front end 254 may select signals received from one of the antennas 252 for processing. For certain aspects of the present disclosure, a combination of the signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal.

Those skilled in the art will recognize the techniques described herein may be generally applied in systems utilizing any type of multiple access schemes, such as TDMA, SDMA, Orthogonal Frequency Division Multiple Access (OFDMA), CDMA, SC-FDMA, TD-SCDMA, and combinations thereof.

### Example Receiver Carrier Aggregation Frequency Generation

A local oscillator (LO) is typically included in radio frequency front-ends (RFFEs), such as RFFE 222 or 254, to generate a signal utilized to convert a signal of interest to a different frequency using a mixer. Known as heterodyning, this frequency conversion process produces the sum and difference frequencies of the LO frequency and the frequency of the signal of interest. The sum and difference frequencies are referred to as the beat frequencies. While it is desirable for the output of an LO to remain stable in frequency, tuning to different frequencies indicates using a variable-frequency oscillator, which involves compromises between stability and tunability. Contemporary systems employ frequency synthesizers with a voltage-controlled oscillator (VCO) to generate a stable, tunable LO with a particular tuning range.

Carrier aggregation (CA) is used in some radio access technologies (RATs), such as LTE-A, in an effort to increase the bandwidth, and thereby increase bitrates. In carrier aggregation, multiple frequency resources (i.e., carriers) are allocated for sending data. Each aggregated carrier is referred to as a component carrier (CC). In LTE Rel-10, for example, up to five component carriers can be aggregated, leading to a maximum aggregated bandwidth of 100 MHz. The allocation of resources may be contiguous or non-contiguous. Non-contiguous allocation may be either intra-band (i.e., the component carriers belong to the same operating frequency band, but have one or more gaps in between) or inter-band (in which case the component carriers belong to different operating frequency bands).

With carrier aggregation, receiving voice or data in two different channels concurrently may entail two receiver chains and two frequency synthesizers, one frequency synthesizer per receiver chain. The two frequency synthesizers may operate simultaneously, which may create problems if the two VCOs in the synthesizers operate at the same or similar frequencies. In this case, the VCOs may couple to each other and cause phase error and spurs. Conventional designs may use two separate integrated circuits (ICs) in an effort to weaken the coupling between the two VCOs. The coupling is typically much stronger for VCOs on the same IC.

Accordingly, what is needed are techniques and apparatus for a carrier aggregation frequency plan to avoid VCO pulling/coupling.

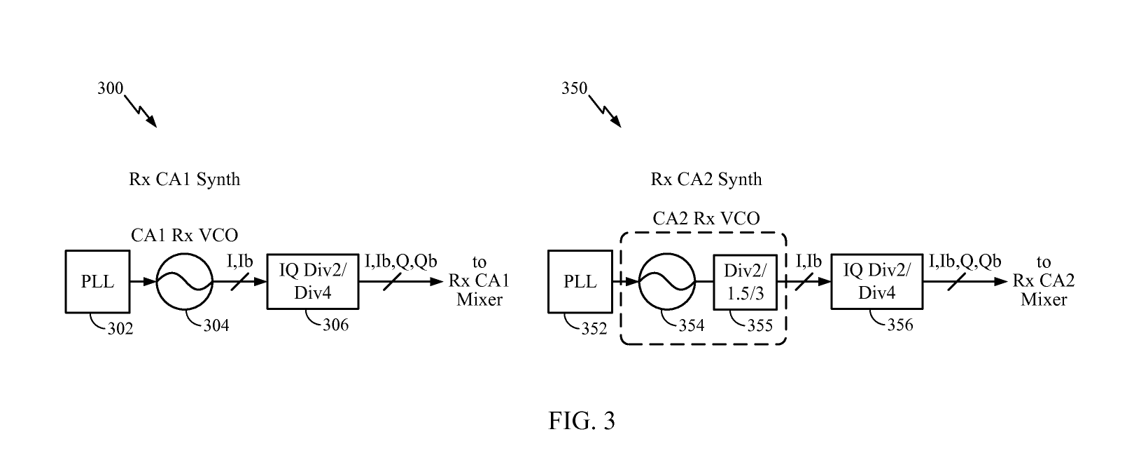

FIG. 3 is a block diagram of an example frequency generating circuit for receiver carrier aggregation, in accordance with certain aspects of the present disclosure. The frequency generating circuit comprises a first frequency synthesizer circuit 300 (labeled “Rx CA1 Synth”) and a second frequency synthesizer circuit 350 (labeled “Rx CA2 Synth”). Although only two receiver chains are shown, aspects of the present disclosure may be extended to three or more receiver chains.

The first frequency synthesizer circuit 300 includes a phase-locked loop (PLL) 302 and a first VCO 304 (labeled “CA1 Rx VCO”), which may operate at or around 4 GHz, for example. Wireless communication systems transmitting radio frequency (RF) signals typically utilize in-phase (I) and quadrature (Q) components, where the Q component is approximately 90° out of phase with the I component. To generate the I and Q local oscillating signals, the output oscillating signal of the first VCO is sent to a frequency dividing circuit 306, which may be configured to divide the first VCO's output frequency by 2 or by 4 and phase shift the resulting I local oscillating signal to generate the Q local oscillating signal. For example, if the operating frequency of the first VCO is 4 GHz, the frequency dividing circuit 306 may generate I and Q local oscillating signals at 2 GHz or 1 GHz. The I and Q local oscillating signals are mixed in a mixer (not shown) with signals received via an antenna 252 or 224 and a low noise amplifier (LNA) (not shown) associated with the first receive chain in the RFFE 222 or 254.

The second frequency synthesizer circuit 350 also includes a PLL 352 and a VCO, but the second VCO 354 (labeled “CA2 Rx VCO”) operates at a different frequency than the first VCO 304. In this manner, the first and second VCOs do not influence each other and potentially create spurs. For example, if the first VCO 304 operates at 4 GHz, the second VCO 354 may operate at or around 6 or 8 GHz. To generate the I and Q local oscillating signals, the output oscillating signal of the second VCO 354 may be sent to another frequency dividing circuit. However, this other frequency dividing circuit may comprise two or more frequency dividing stages. For example, the first stage 355 may be configured to initially divide the second VCO's output frequency by 2, by 1.5, or by 3. The second stage 356 may be configured to frequency divide the output of the first stage by 2 or by 4, leading to overall divisions of 3, 4, 6, 8, or 12. The second stage 356 may also be configured to phase shift the resulting I local oscillating signal 90° to generate the Q local oscillating signal.

For example, if the second VCO 354 has an operating frequency of 8 GHz, the first stage 355 may be configured to divide by 2, such that the I and Q local oscillating signals have a frequency of 2 GHz or 1 GHz after division by the second stage 356. In the alternative, if the second VCO 354 has an operating frequency of 6 GHz, the first stage 355 may be configured to divide by 1.5 or by 3, such that the I and Q local oscillating signals also have a frequency of 2 GHz or 1 GHz after division by the second stage 356.

With this receiver carrier aggregation frequency plan, pulling or coupling between the two VCOs may be avoided, even if the two VCOs are implemented on the same IC.

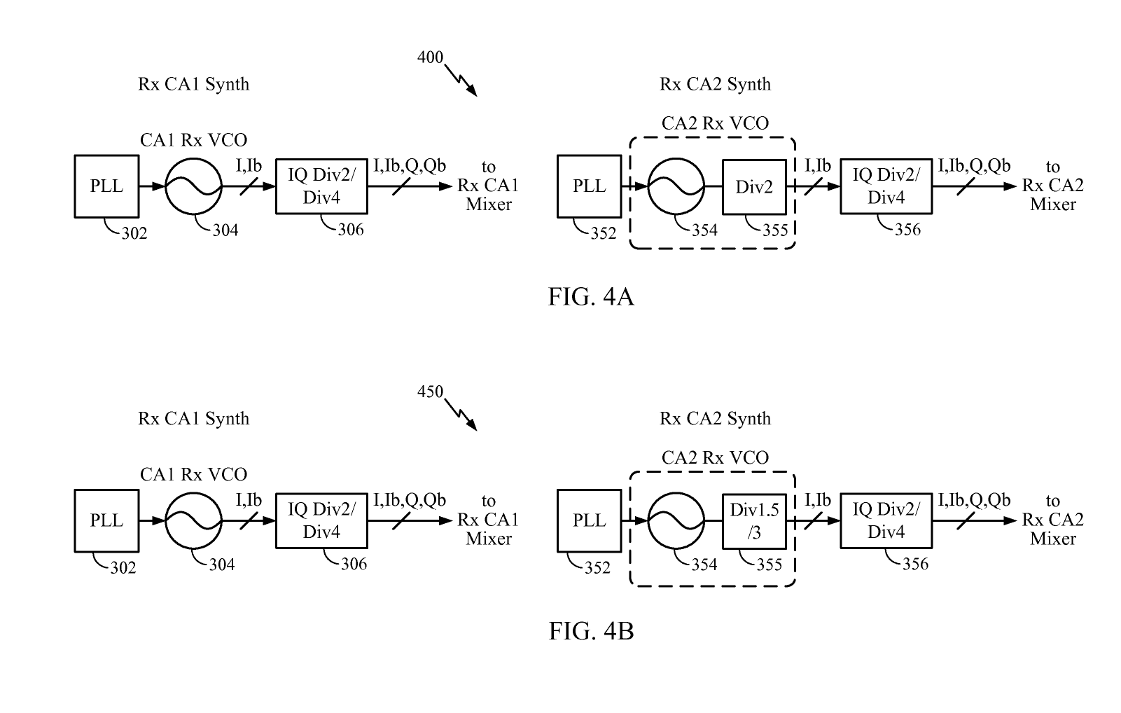

FIG. 4A illustrates an example primary carrier aggregation frequency plan 400 for the circuit of FIG. 3, in accordance with certain aspects of the present disclosure. In FIG. 4A, the first stage 355 of the frequency dividing circuit in the second frequency synthesizer circuit 350 (Rx CA2 Synth) is configured to divide by 2. In this case, the second VCO 354 (CA2 Rx VCO) may have an operating frequency twice that of the first VCO 304 (CA1 Rx VCO). This may be considered the primary CA2 frequency plan. One may note that the additional frequency division by 2 in the first stage 355 of the second frequency synthesizer circuit 350 need not provide quadrature phases for the local oscillating signals. This is because the second stage 356 (capable of frequency division by 2 or by 4) of the second frequency synthesizer circuit 350 may be configured to generate the quadrature phase local oscillating signal.

FIG. 4B illustrates an example secondary carrier aggregation frequency plan 450 for the circuit of FIG. 3, in accordance with certain aspects of the present disclosure. In FIG. 4B, the first stage 355 of the frequency dividing circuit in the second frequency synthesizer circuit 350 (Rx CA2 Synth) is configured to divide by 1.5 or by 3. In this case, the second VCO 354 (CA2 Rx VCO) may have an operating frequency 1.5 or 3 times that of the first VCO 304 (CA1 Rx VCO), respectively. This may be considered the alternative (or secondary) CA2 frequency plan. One may note that the additional frequency division by 1.5 or 3 in the first stage of the second frequency synthesizer circuit 350 need not provide quadrature phases for the local oscillating signals.

The various operations or methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting may comprise a transmitter (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for receiving may comprise a receiver (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for processing or means for determining may comprise a processing system, which may include one or more processors, such as the RX data processor 270, the TX data processor 288, and/or the controller 280 of the user terminal 120 illustrated in FIG. 2.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A circuit for generating a first signal and a second signal, comprising:
a first voltage controlled oscillator (VCO) configured to output the first signal at a first frequency and associated with a first receive chain for receiving a first carrier of an aggregated resource; and
a second VCO configured to output the second signal at a second frequency and associated with a second receive chain for receiving a second carrier of the aggregated resource, wherein the second frequency is different than the first frequency.

2. The circuit of claim 1, wherein the first VCO and the second VCO are implemented on a single integrated circuit (IC).

3. The circuit of claim 1, wherein the first frequency is one half of the second frequency.

4. The circuit of claim 1, wherein the first frequency is 4 GHz and wherein the second frequency is 8 GHz.

5. A local oscillator (LO) generation circuit for generating first and second local oscillating signals, comprising:
a first voltage controlled oscillator (VCO) configured to output a first signal at a first frequency and associated with a first receive chain for receiving a first carrier of an aggregated resource;
a first frequency dividing circuit configured to divide the first frequency of the first signal to generate the first local oscillating signal;
a second VCO configured to output a second signal at a second frequency and associated with a second receive chain for receiving a second carrier of the aggregated resource, wherein the second frequency is different than the first frequency; and
a second frequency dividing circuit configured to divide the second frequency of the second signal to generate the second local oscillating signal.

6. The LO generation circuit of claim 5, wherein the first VCO and the second VCO are implemented on a single integrated circuit (IC).

7. The LO generation circuit of claim 5, wherein the first frequency is two thirds of the second frequency.

8. The LO generation circuit of claim 5, wherein the first frequency is 4 GHz and wherein the second frequency is 6 GHz.

9. The LO generation circuit of claim 5, wherein the first frequency dividing circuit comprises at least one of a divide-by-2 circuit or a divide-by-4 circuit.

10. The LO generation circuit of claim 5, wherein the second frequency dividing circuit comprises:
a first stage configured to initially divide the second frequency of the second signal; and
a second stage for subsequently frequency dividing an output signal of the first stage to generate the second local oscillating signal.

11. The LO generation circuit of claim 10, wherein the first stage comprises at least one of a divide-by-1.5 circuit, a divide-by-2 circuit, or a divide-by-3 circuit.

12. The LO generation circuit of claim 10, wherein the second stage comprises at least one of a divide-by-2 circuit or a divide-by-4 circuit.

13. An apparatus for wireless communications, comprising:
a first antenna;
a second antenna;
a first receive chain configured to mix a first carrier of an aggregated resource received via the first antenna with a first local oscillating signal;
a second receive chain configured to mix a second carrier of the aggregated resource received via the second antenna with a second local oscillating signal; and
a local oscillator (LO) generation circuit for generating the first and second local oscillating signals, comprising:
a first voltage controlled oscillator (VCO) configured to output a first signal at a first frequency, wherein the first VCO is associated with the first receive chain;
a first frequency dividing circuit configured to divide the first frequency of the first signal to generate the first local oscillating signal;
a second VCO configured to output a second signal at a second frequency, wherein the second VCO is associated with the second receive chain and wherein the second frequency is different than the first frequency; and
a second frequency dividing circuit configured to divide the second frequency of the second signal to generate the second local oscillating signal.

14. The apparatus of claim 13, wherein the first VCO and the second VCO are implemented on a single integrated circuit (IC).

15. The apparatus of claim 13, wherein the first frequency is one third of the second frequency.

16. The apparatus of claim 13, wherein the first frequency is 4 GHz and wherein the second frequency is 12 GHz.

17. The apparatus of claim 13, wherein the first frequency dividing circuit comprises at least one of a divide-by-2 circuit or a divide-by-4 circuit.

18. The apparatus of claim 13, wherein the second frequency dividing circuit comprises:
a first stage configured to initially divide the second frequency of the second signal; and
a second stage for subsequently frequency dividing an output signal of the first stage to generate the second local oscillating signal.

19. The apparatus of claim 18, wherein the first stage comprises at least one of a divide-by-1.5 circuit, a divide-by-2 circuit, or a divide-by-3 circuit.

20. The apparatus of claim 18, wherein the second stage comprises at least one of a divide-by-2 circuit or a divide-by-4 circuit.
